(19) United States
(12) Patent Application Publication
(10) Pub. No.: US 2020/0135236 A1
(43) Pub. Date: Apr. 30, 2020

(54) HUMAN POSE VIDEO EDITING ON SMARTPHONES

(71) Applicant: MediaTek Inc., Hsinchu (TW)

(72) Inventors: Shih-Jung Chuang, Hsinchu (TW); Cheng-Lung Jen, Hsinchu (TW); Chih-Chung Chiang, Hsinchu (TW); Hsin-Ying Ko, Hsinchu (TW)

(21) Appl. No.: 16/173,734

(22) Filed: Oct. 29, 2018

(51) Int. Cl. G11B 27/031; G06F 3/0488; G06F 3/0484; G06T 3/00

(52) U.S. Cl. CPC G11B 27/031; G06T 3/0093; G06F 3/04845; G06F 3/04883

(57) ABSTRACT

A mobile device enables a user to edit a video containing a human figure, such that an original human pose is modified into a target human pose in the video. In response to a user command, the mobile device first identifies key points of the human figure from a frame of the video. The user command indicates a target position of a given key point of the key points. The mobile device generates a target frame including the target human pose, with the given key point of the target human pose at the target position. An edited frame sequence is generated on the display including the target frame. The edited frame sequence shows the movement of the human pose transitioning into the target human pose.

### TECHNICAL FIELD

Embodiments of the invention relate to identifying and editing a human pose in a video on a mobile device.

### BACKGROUND

Human pose detection refers to the detection of key points of a human figure in an image. The positions of the key points describe the human pose. Each key point is associated with a body part such as the head, a shoulder, a hip joint, a knee and a foot. Human pose detection enables the determination of whether a person detected in an image is kicking his leg, raising his elbow, standing up or sitting down.

Conventionally, a human pose is captured by outfitting a human subject with a marker suit having embedded tracking sensors on several key locations. Such an approach is cumbersome, time-consuming and costly. Marker-less methods for pose estimation have been developed but require significant computing power, which is an obstacle for devices limited by computing resources, such as mobile devices.

### SUMMARY

In one embodiment, a mobile device is provided to generate a target human pose in a video. The mobile device includes processing hardware, memory coupled to the processing hardware, and a display. The processing hardware is operative to: identify key points of a human figure from a frame of the video in response to a user command, the user command further indicating a target position of a given key point of the key points; generate a target frame including the target human pose, with the given key point of the target human pose at the target position; and generate on the display an edited frame sequence including the target frame. The edited frame sequence shows movement of the human pose transitioning into the target human pose.

In another embodiment, a method is provided to generate a target human pose in a video. The method comprises: identifying key points of a human figure from a frame of the video in response to a user command, the user command further indicating a target position of a given key point of the key points; generating a target frame including the target human pose, with the given key point of the target human pose at the target position; and generating on a display an edited frame sequence including the target frame. The edited frame sequence shows movement of the human pose transitioning into the target human pose.

Other aspects and features will become apparent to those ordinarily skilled in the art upon review of the following description of specific embodiments in conjunction with the accompanying figures.

### BRIEF DESCRIPTION OF THE DRAWINGS

The present invention is illustrated by way of example, and not by way of limitation, in the figures of the accompanying drawings in which like references indicate similar elements. It should be noted that different references to “an” or “one” embodiment in this disclosure are not necessarily to the same embodiment, and such references mean at least one. Further, when a particular feature, structure, or characteristic is described in connection with an embodiment, it is submitted that it is within the knowledge of one skilled in the art to effect such feature, structure, or characteristic in connection with other embodiments whether or not explicitly described.

FIG. 1 illustrates an example of editing a human pose in a video on a mobile device according to one embodiment.

FIG. 2 illustrates an example of an edited frame sequence according to one embodiment.

FIG. 3 is a diagram illustrating operations performed by a mobile device for editing a human pose in a video according to one embodiment.

FIG. 4 is a diagram illustrating main components of a convolutional neural network (CNN) accelerator according to one embodiment.

FIG. 5 illustrates an inverse kinematics transformation performed in connection with human pose editing according to one embodiment.

FIG. 6 illustrates a global warping transformation performed in connection with human pose editing according to one embodiment.

FIG. 7 illustrates an example of a mobile device according to one embodiment

FIG. 8 is a flow diagram illustrating a method for a mobile device to generate a target human pose in a video according to one embodiment.

### DETAILED DESCRIPTION

In the following description, numerous specific details are set forth. However, it is understood that embodiments of the invention may be practiced without these specific details. In other instances, well-known circuits, structures and techniques have not been shown in detail in order not to obscure the understanding of this description. It will be appreciated, however, by one skilled in the art, that the invention may be practiced without such specific details. Those of ordinary skill in the art, with the included descriptions, will be able to implement appropriate functionality without undue experimentation.

Embodiments of the invention enable the editing of a human pose captured in a video. In one embodiment, the pose of a human figure is identified in a video, where the pose is defined by a number of key points which describe joint positions and joint orientations. A user, such as a smartphone user, may view the video on a display of the smartphone and edit the position of a key point in a frame of the video. The user-edited position of the key point is referred to as the target position. In response to the user input, the human pose is automatically modified in the video, including a target frame that shows the key point at the target position and the neighboring frames that precede and/or follow the target frame. For example, a human figure may extend his arm in an original frame sequence of the video, and a user may edit one frame in the video to bend the arm. A method and a system are developed to automatically generate an edited frame sequence based on the original frame sequence and the target position of the edited key point. In the edited frame sequence, the human figure is shown to bend his arm in a natural and smooth movement.

In one embodiment, a video editing application may be provided and executed by the user's smartphone, which according to a user command automatically generates an edited frame sequence with smooth transitions into and out of the target frame.

Although the terms “smartphone” and “mobile device” are used in this disclosure, it is understood that the methodology described herein is applicable to any computing and/or communication device capable of displaying a video, identifying a human pose and key points, editing one or more of the key points according to a user command, and generating an edited video. It is understood that the term “mobile device” includes a smartphone, a tablet, a network-connected device, a gaming device, etc. The video to be edited on a mobile device may be captured by the same mobile device, or by a different device and then downloaded to the mobile device. In one embodiment, a user may edit a human pose in a frame of the video, run a video editing application on the mobile device to generate an edited video, and then share the edited video on social media.

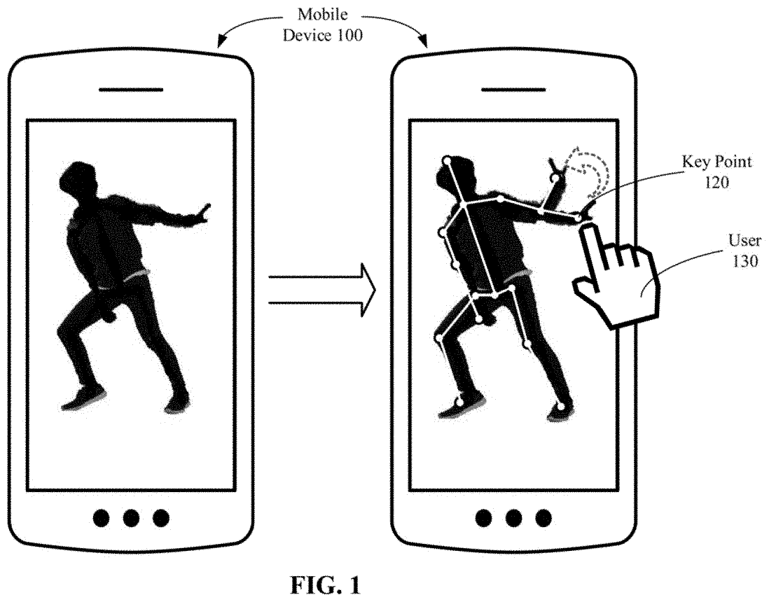

FIG. 1 illustrates an example of editing a human pose in a video on a mobile device 100 according to one embodiment. On the left side of FIG. 1 is the mobile device 100 displaying a human figure extending his left arm. A user 130 may edit the pose of the human figure, as shown on the right side of FIG. 1, such that the human figure is shown as bending his left arm upwards. In one embodiment, the user 130 may edit the pose in the displayed image by moving a key point 120 (representing the left hand) upwards, as illustrated by the dotted arrow. In one embodiment, each of the key points is movable on the display in accordance to a user command (e.g., a user-directed motion on a touch screen). In one embodiment, the displayed image may be a frame of a video. As will be described in detail below, the mobile device 100 includes hardware and software that enable a user to edit a human pose in a video in a user-friendly manner.

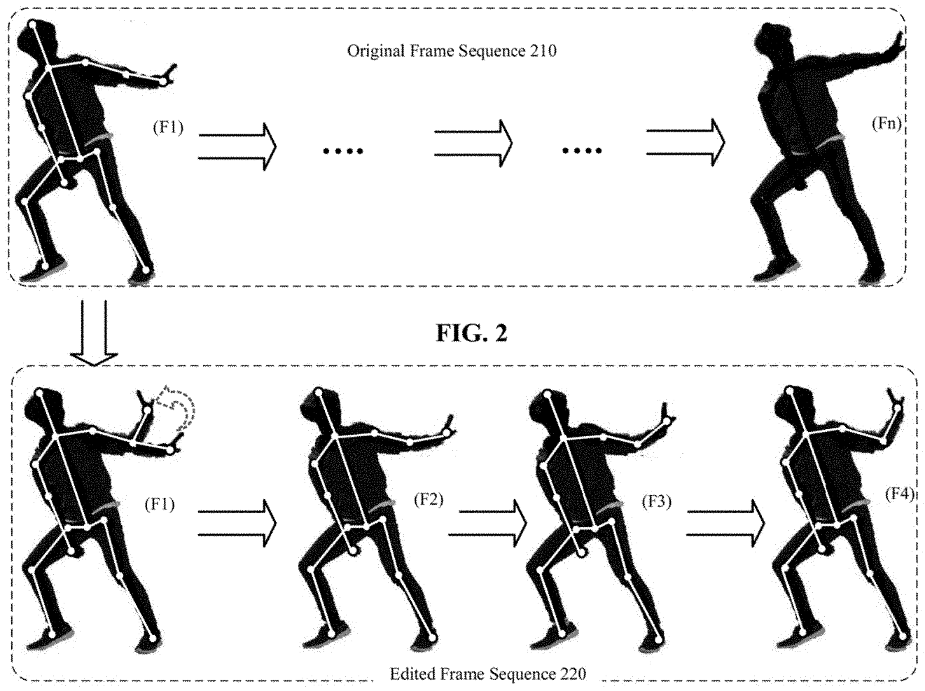

FIG. 2 illustrates an example of an edited frame sequence in a video according to one embodiment. The video includes an original frame sequence 210 in which a human figure extends his left arm upwards. It is understood that the original frame sequence 210 may contain two or more frames of the video; in this example, only the beginning frame (F1) and the ending frame (Fn) of the original frame sequence 210 are shown.

As an example, the video may be displayed and edited on the mobile device 100 of FIG. 1. A user of the mobile device 100 may wish to change the left arm movement of the human figure in the original frame sequence 210, such that the human figure bends his left arm upwards instead of extending his left arm upwards. In this example, the user first selects the frame to input the user's edits (e.g., frame (F1)), or a frame sequence to be replaced (e.g., the original frame sequence 210). The mobile device 100 identifies and displays key points of the human figure in frame (F1). In one embodiment, the user may drag the left hand (e.g., the key point on the left hand) of the human figure upwards in frame (F1) on a touch screen. The user's input defines the target position of the key point on the left hand. In response to the user's input, the mobile device 100 automatically generates the target frame (F4), as well as the intermediate frames (frames (F2) and (F3)) between the user-selected frame (frame (F1)) and the target frame (F4). Frames (F1)-(F4) form an edited frame sequence 220, which replaces the original frame sequence 210 to form an edited video. When the edited video is replayed, the left arm movement of the human figure is shown as in frames (F1)-(F4), without the key points shown on the display.

In one embodiment, the key points of the human figure are shown on the display after the mobile device 100 receives the user's command to edit the video (e.g., when the user starts running a video editing application on the mobile device 100). The user may select a frame sequence (e.g., the original frame sequence 210) to be replaced by the edited frame sequence 220. The user may input his edits in the first frame of the selected frame sequence to define the target pose in the last frame (i.e., the target frame) of the edited frame sequence 220. The number of intermediate frames generated by the mobile device 100 between the original pose (in frame (F1)) and the target pose (in frame (F4)) may be controlled by a predetermined setting or a user-configurable setting (e.g., 1-2 seconds of frames such as 30-60 frames), and/or may be dependent on the amount of movement between the original pose and the target pose, to produce a smooth movement. In one embodiment, additional frames may also be generated and added after the target frame (e.g., frame (F4)) to produce a smooth movement of the human figure.

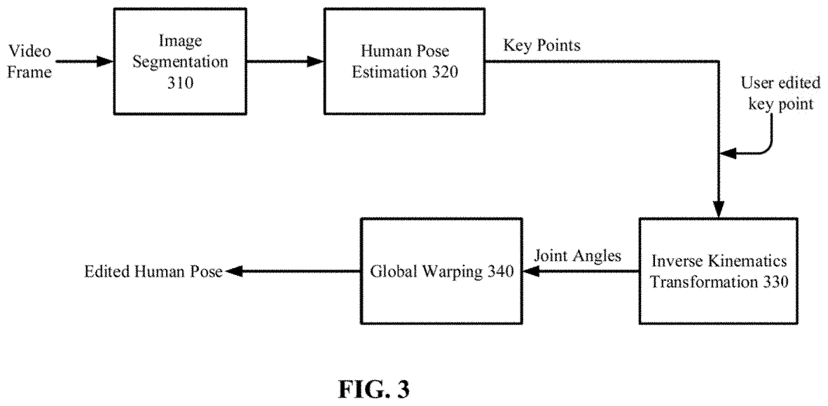

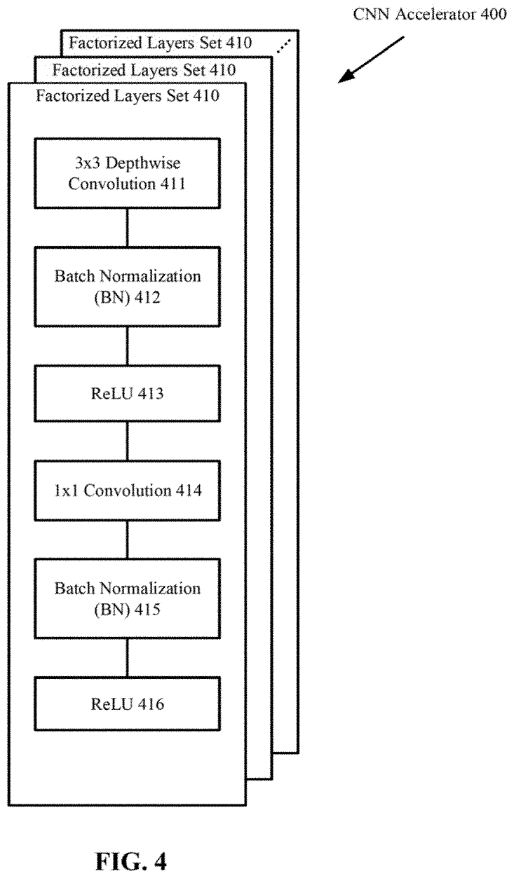

FIG. 3 is a diagram illustrating operations performed by a mobile device, such as the mobile device 100 of FIG. 1, for editing a human pose in a video according to one embodiment. The video may be captured, downloaded or otherwise stored in the mobile device 100. In one embodiment, the mobile device 100 performs image segmentation 310 to extract (i.e., crop) a human figure of interest from the background of an image in the video, and then performs human pose estimation 320 to identify the pose (i.e., key points) of the human figure. In one embodiment, the image segmentation 310 and the human pose estimation 320 may be computed by convolution neural network (CNN) computations. In one embodiment, the mobile device 100 includes a hardware accelerator, which is also referred to as a CNN accelerator for performing CNN computations. Further details of the CNN accelerator will be provided with reference to FIG. 4.

With respect to human pose estimation 320, the mobile device 100 may identify the key points of a human pose from a human figure image by performing CNN-based parts identification and parts association. Parts identification refers to identifying the key points of a human figure, and parts association refers to associating the key points with body parts of a human figure. The human pose estimation 320 may be performed on the human figure cropped from the background image, and CNN computations are performed to associate the identified key points with body parts of the cropped human figure. CNN-based algorithms for image segmentation and human pose estimation are known in the art; the descriptions of these algorithms are beyond the scope of this disclosure. It is noted that the mobile device 100 may perform CNN computations to identify the human pose according to a wide range of algorithms.

After the key points of the human figure are identified and displayed on the mobile device 100, a user of the mobile device 100 may input a command to move any of the key points on the display. The user command may include a user-directed motion on a touch screen to move a key point to a target position. The user may move one or more of the key points via a user interface; e.g., by dragging a key point (referred to as the given key point) to a target position by hand or by a stylus pen on a touch screen or touch pad of the mobile device 100. The mobile device 100 based on the edited coordinates of the given key point (e.g., in the Cartesian space) computes the corresponding joint angles of the human figure. In one embodiment, the mobile device 100 converts the Cartesian coordinates to the corresponding joint angles by applying an inverse kinematics transformation 330. From the joint angles, the mobile device 100 computes the resulting key points which define the target pose, where the resulting key points include the given key point moved by the user and the other key points which are moved from their respective original positions caused by movement of the given key point.

After the resulting key points are computed, the mobile device 100 applies global warping 340 to transform the original human figure pixels (having the original pose) to the target human figure pixels (having the target pose). The original human figure pixels are in an original coordinate system and the target human figure pixels are in a new coordinate system. The global warping 340 maps each pixel value of the human figure in the original coordinate system to the new coordinate system, such that the human figure is shown to have the target pose in the edited video. For example, if Q and P are the original coordinates of the two key points that define an arm in the original pose, and Q′ and P′ are the new coordinates of the corresponding resulting key points in the target pose, a transformation (T) can be computed from the line-pairs Q-P and Q′-P′. This transformation (T) can be used to warp pixels on the arm. If X is a pixel (or pixels) on the arm in the original pose, X′=T·X is the corresponding pixel (or pixels) on the arm in the target pose.

In one embodiment, the inverse kinematics transformation 330 and the global warping 340 are also performed on each intermediate state of the human pose in each intermediate frame (which precedes the target frame) to produce a smooth path of movement of the human figure. A smooth simulated path of movement of posture is computed with inverse kinematics transformation 330 and the pose within the time window of the intermediate frames are warped accordantly to present a natural human pose.

FIG. 4 is a diagram illustrating main components of a CNN accelerator 400 according to one embodiment. The CNN accelerator 400 includes multiple sets of factorized convolutional layers (herein referred to as factorized layers sets 410). In contrast to a conventional convolutional layer, the CNN accelerator 400 performs depth-wise separable convolutions where each factorized layers set 410 includes a first factorized layer (3×3 depth-wise convolution 411) and a second factorized layer (1×1 convolution 414). Each factorized layer is followed by a batch normalization (BN) (412, 415) and a rectifier linear unit (ReLU) (413, 416). The CNN accelerator 400 may also include additional neural network layers such as a fully-connected layer, a pooling layer, a softmax layer, etc. The CNN accelerator 400 includes hardware components specialized for accelerating neural network operations including convolutional operations, depth-wise convolutional operations, dilated convolutional operations, deconvolutional operations, fully-connected operations, activation, pooling, normalization, bi-linear resize, and element-wise mathematical computations. More specifically, the CNN accelerator 400 includes multiple compute units and memory (e.g., Static Random Access Memory (SRAM)), where each compute unit further includes multipliers and adder circuits, among others, for performing mathematical operations such as multiply-and-accumulate (MAC) operations to accelerate the convolution, activation, pooling, normalization, and other neural network operations. The CNN accelerator 400 performs fixed and floating point neural network operations. In connection with the human pose editing described herein, the CNN accelerator 400 performs image segmentation 310 and human pose estimation 310 in FIG. 3.

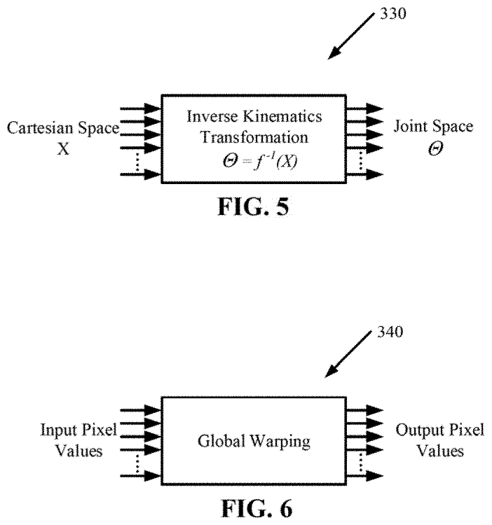

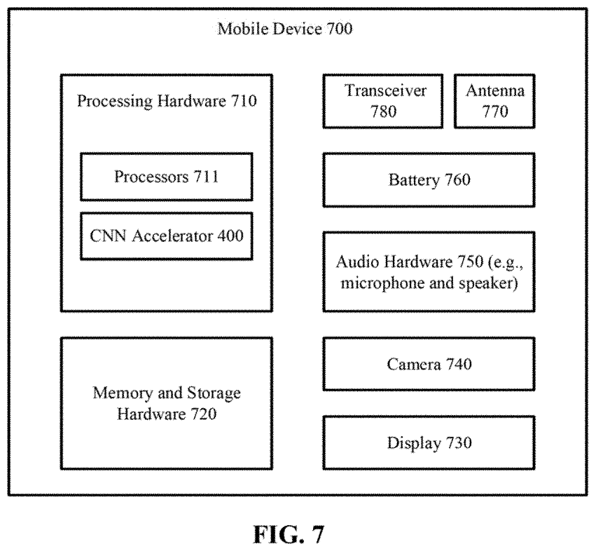

FIG. 5 illustrates the inverse kinematics transformation 330 (f⁻¹) performed in connection with human pose editing according to one embodiment. The inverse kinematics transformation 330 may be executed by one or more general-purpose processors or a special-purpose circuit of a mobile device (e.g., the mobile device of FIG. 1 or FIG. 7). The inverse kinematics transformation 330 transforms an input in the Cartesian space to the joint space; more specifically, the inverse kinematics transformation 330 computes the vector of joint degree-of-freedoms (DOFs) that cause an end effector (e.g., a human figure) to reach the user-edited target state. Given a set of input coordinates representing the target position of an edited key point, the inverse kinematics transformation 330 outputs a set of joint angles that define the target pose.

FIG. 6 illustrates the global warping 340 performed in connection with human pose editing according to one embodiment. The global warping 340 may be executed by one or more general-purpose processors or a special-purpose circuit of a mobile device (e.g., the mobile device of FIG. 1 or FIG. 7). The global warping 340 is a projective transformation which has at least the following properties: origin does not necessarily map to origin, lines map to lines, parallel lines do not necessarily remain parallel, ratios are not preserved, closed under composition, and models change of basis. In one embodiment, the global warping 340 may be implemented as a matrix transformation.

FIG. 7 illustrates an example of a mobile device 700 according to one embodiment. The mobile device 700 may be an example of the mobile device 100 of FIG. 1, which provides a platform for the aforementioned human pose editing in a video. The mobile device 700 includes processing hardware 710, which further includes processors 711 (e.g., central processing units (CPUs), graphics processing units (GPUs), digital processing units (DSPs), multimedia processors, other general-purpose and/or special-purpose processing circuitry.). In some systems, the processor 711 may be the same as a “core” or “processor core,” while in some other systems a processor may include multiple cores. Each processor 711 may include arithmetic and logic units (ALUs), control circuitry, cache memory, and other hardware circuitry. The processing hardware 710 further includes the CNN accelerator 400 (FIG. 4) for performing CNN computations. Non-limiting examples of the mobile device 700 include smartphones, smartwatches, tablets, and other portable and/or wearable electronic devices.

The mobile device 700 further includes memory and storage hardware 720 coupled to the processing hardware 710. The memory and storage hardware 720 may include memory devices such as dynamic random access memory (DRAM), static RAM (SRAM), flash memory and other volatile or non-volatile memory devices. The memory and storage hardware 720 may further include storage devices, for example, any type of solid-state or magnetic storage device.

The mobile device 700 may also include a display 730 to display information such as pictures, videos, messages, Web pages, games, texts, and other types of text, image and video data. In one embodiment, the display 730 and a touch screen may be integrated together.

The mobile device 700 may also include a camera 740 for capturing images and videos, which can then be viewed on the display 730. The videos may be edited via a user interface, such as a keyboard, a touch pad, a touch screen, a mouse, etc. The mobile device 700 may also include audio hardware 750, such as a microphone and a speaker, for receiving and generating sounds. The mobile device 700 may also include a battery 760 to supply operating power to hardware components of the mobile device 700.

The mobile device 700 may also include an antenna 770 and a digital and/or analog radio frequency (RF) transceiver 780 to transmit and/or receive voice, digital data and/or media signals, including the aforementioned video of edited human pose.

It is understood the embodiment of FIG. 7 is simplified for illustration purposes. Additional hardware components may be included. For example, the mobile device 700 may also include network hardware (e.g., a modem) for connecting to networks (e.g., a personal area network, a local area network, a wide area network, etc.). The network hardware as well as the antenna 770 and the RF transceiver 780 enable a user to share the aforementioned video of edited human pose online; e.g., on social media or other networked forums (e.g., websites on the Internet). In one embodiment, the mobile device 700 may upload an edited frame sequence to a server (e.g., a cloud server), via the network hardware, the antenna 770 and/or the RF transceiver 780, to be retrieved by other mobile devices.

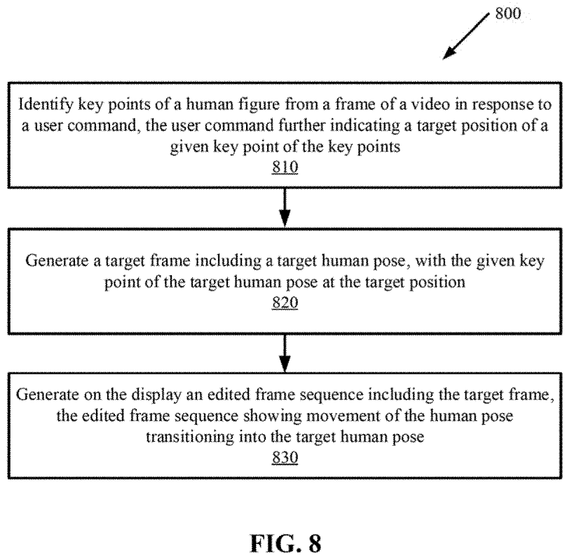

FIG. 8 is a flow diagram illustrating a method 800 for a mobile device to generate a target human pose in a video according to one embodiment. The method 800 may be performed by the mobile device 100 of FIG. 1, the mobile device 700 of FIG. 7, or another computing or communication device. In one embodiment, the mobile device 700 includes circuitry (e.g., the processing hardware 710 of FIG. 7) and a machine-readable medium (e.g., the memory 720) which stores instructions when executed cause the mobile device 700 to perform the method 800.

The method 800 begins at step 810 with the mobile device identifying key points of a human figure from a frame of a video in response to a user command. The user command further indicates a target position of a given key point of the key points. At step 820, the mobile device generates a target frame including a target human pose. The given key point of the target human pose is at the target position. At step 830, the mobile device generates on the display an edited frame sequence including the target frame. The edited frame sequence shows the movement of the human pose transitioning into the target human pose.

The operations of the flow diagram of FIG. 8 have been described with reference to the exemplary embodiments of FIG. 1 and FIG. 7. However, it should be understood that the operations of the flow diagram of FIG. 8 can be performed by embodiments of the invention other than the embodiments of FIG. 1 and FIG. 7, and the embodiments of FIG. 1 and FIG. 7 can perform operations different than those discussed with reference to the flow diagram. While the flow diagram of FIGS. 8 shows a particular order of operations performed by certain embodiments of the invention, it should be understood that such order is exemplary (e.g., alternative embodiments may perform the operations in a different order, combine certain operations, overlap certain operations, etc.).

Various functional components or blocks have been described herein. As will be appreciated by persons skilled in the art, the functional blocks will preferably be implemented through circuits (either dedicated circuits, or general purpose circuits, which operate under the control of one or more processors and coded instructions), which will typically comprise transistors that are configured in such a way as to control the operation of the circuity in accordance with the functions and operations described herein.

While the invention has been described in terms of several embodiments, those skilled in the art will recognize that the invention is not limited to the embodiments described, and can be practiced with modification and alteration within the spirit and scope of the appended claims. The description is thus to be regarded as illustrative instead of limiting.

1. A mobile device operative to generate a target human pose in a video, comprising:
processing hardware including a convolutional neural network (CNN) accelerator;
memory coupled to the processing hardware; and
a display to display the video containing a movement sequence of a human figure wherein the video is captured by a camera, the processing hardware operative to:
calculate, by the CNN accelerator, key points of the human figure in a frame of the video in response to a user command, the user command further indicating a target position of a given key point of the key points;
generate a target frame including the target human pose, with the given key point of the target human pose at the target position; and
generate on the display an edited frame sequence including the target frame, the edited frame sequence showing movement of the human pose transitioning into the target human pose.

2. The mobile device of claim 1, wherein the
CNN accelerator is operative to perform CNN computations to crop the human figure from a background image.

3. The mobile device of claim 2, wherein the CNN accelerator is operative to perform CNN computations to associate the key points with body parts of the cropped human figure.

4. The mobile device of claim 1, further comprising circuitry operative to upload the edited frame sequence to a server to be retrieved by other mobile devices.

5. The mobile device of claim 1, wherein each of the key points is movable on the display in accordance to the user command.

6. The mobile device of claim 1, further comprising a touch screen, wherein the user command includes a user-directed motion on the touch screen to move the key point to the target position.

7. The mobile device of claim 1, wherein the user command selects a frame sequence in the video to be replaced by the edited frame sequence.

8. The mobile device of claim 1, wherein the user command selects the frame in the video to indicate the target position of the key point, and the processing hardware is operative to:
generate intermediate frames to follow the selected frame in the edited frame sequence, each intermediate frame showing an incremental progression of the movement of the human pose that transitions into the target human pose in the target frame.

9. The mobile device of claim 1, wherein the processing hardware is further operative to:
perform inverse kinematics transformations to obtain joint angles corresponding to the target human pose at the target position.

10. The mobile device of claim 9, wherein the processing hardware is further operative to:
calculate a global warping transformation on pixels of the human figure based on the joint angles; and
perform the global warping transformation on the pixels of the human figure to transform the human figure from an original human pose to the target human pose.

11. A method for generating a target human pose in a video on a display of a mobile device, comprising:
displaying the video containing a movement sequence of a human figure, wherein the video is captured by a camera;
performing convolutional neural network (CNN) computations to calculate key points of the human figure from a frame of the video in response to a user command, the user command further indicating a target position of a given key point of the key points;
generating a target frame including the target human pose, with the given key point of the target human pose at the target position; and
generating on the display an edited frame sequence including the target frame, the edited frame sequence showing movement of the human pose transitioning into the target human pose.

12. The method of claim 11, further comprising:
performing the CNN computations to crop the human figure from a background image.

13. The method of claim 12, further comprising:
performing the CNN computations to associate the key points with body parts of the cropped human figure.

14. The method of claim 11, further comprising: uploading the edited frame sequence to a server to be retrieved by other mobile devices.

15. The method of claim 11 wherein each of the key points is movable on the display in accordance to the user command.

16. The method of claim 11, wherein the mobile device includes a touch screen and the user command includes a user-directed motion on the touch screen to move the key point to the target position.

17. The method of claim 11, wherein the user command selects a frame sequence in the video to be replaced by the edited frame sequence.

18. The method of claim 11, wherein the user command selects the frame in the video to indicate the target position of the key point, the method further comprising:
generating intermediate frames to follow the selected frame in the edited frame sequence, each intermediate frame showing an incremental progression of the movement of the human pose that transitions into the target human pose in the target frame.

19. The method of claim 11, further comprising:
performing inverse kinematics transformations to obtain joint angles corresponding to the target human pose at the target position.

20. The method of claim 19, further comprising:
calculating a global warping transformation on pixels of the human figure based on the joint angles; and
performing the global warping transformation on the pixels of the human figure to transform the human figure from an original human pose to the target human pose.
